(19) United States
(12) Patent Application Publication
(10) Pub. No.: US 2025/0273450 A1
(43) Pub. Date: Aug. 28, 2025

(54) DETECTOR INLET AND METHOD

(71) Applicant: Smiths Detection-Watford Limited, Hemel Hempstead (GB)

(72) Inventors: Alastair Clark, Hemel Hempstead (GB); Jonathan Richard Atkinson, Hemel Hempstead (GB); Andrew Hobson, Hemel Hempstead (GB)

(21) Appl. No.: 18/857,108

(22) PCT Filed: Apr. 19, 2023
(86) PCT No.: PCT/GB2023/051028

§ 371 Date: Oct. 15, 2024

(30) Foreign Application Priority Data
Apr. 22, 2022 (GB) 2205897.8

(51) Int. Cl. H01J 49/04

(52) U.S. Cl. CPC H01J 49/0422; H01J 49/049

(57) ABSTRACT

Methods and apparatus for providing samples to a detector are provided. A detector inlet for providing a sample to an analytical apparatus for detecting a substance of interest includes a first sampling pathway configured to receive a first flow of air including a vapour for sampling by the analytical apparatus; and a second sampling pathway configured to receive a second flow of air, the second sampling pathway including a heater configured to heat an aerosol, present in the second flow of air, to vaporise the aerosol for sampling by the analytical apparatus; wherein the detector inlet is operable to open and close each of the first and second sampling pathways to enable at least one of the first flow of air and the second flow of air.

### CROSS-REFERENCE TO RELATED APPLICATIONS

The present application is a national stage entry of PCT/GB2023/051028 filed on Apr. 19, 2023, which claims the benefits of GB Patent Application No. 2205897.8 filed on Apr. 22, 2022, the contents of which are hereby incorporated by reference in their entirety.

### BACKGROUND

The present disclosure relates to detection methods and apparatus, and more particularly to methods and apparatus for obtaining samples for detectors, still more particularly to methods and apparatus for providing samples in different forms to a detector. These methods and apparatus may find particular application in spectrometry, for example ion mobility spectrometry and mass spectrometry.

Some detectors, for example some types of ion mobility spectrometers, operate by “inhaling” a stream of gaseous fluid, such as air, into a detector inlet and sampling that air with an analytical apparatus to detect substances of interest. That inhaled stream of air can be sampled from the detector inlet using a sampling inlet such as a pinhole, capillary or membrane inlet.

Some analytical apparatus and particularly some ion mobility spectrometers are adapted for the analysis of vapours, and of gases. Such analytical apparatus may be configured to detect substances of interest, such as narcotics, explosives, and chemical warfare agents. Detection sensitivity, and the reliability of such detectors, may therefore be a significant issue. Some substances of interest may include aerosols. By contrast with a vapour or gas, an aerosol includes fine particles of solid or liquid suspended in a gas. Where the substance has a low vapour pressure, an ion mobility spectrometer may be unable to detect particles of that substance in an aerosol without vaporisation of the aerosol.

Often, handheld, or portable devices may be needed for example for use by military and security personnel, which may require reduced size, weight and complexity compared to other detectors. In general these devices are battery powered and it is desired to extend their battery life.

### BRIEF DESCRIPTION

Embodiments of the present disclosure aim to address related technical problems.

### BRIEF DESCRIPTION OF THE DRAWINGS

Embodiments of the disclosure will now be described, by way of example only, with reference to the accompanying drawings, in which:

FIG. 1 shows a schematic illustration of a detector inlet;

FIGS. 2A to 2C show a schematic illustration of a user-actuatable cap for opening and closing sampling pathways;

FIG. 3 shows a schematic illustration of detector including an ion mobility spectrometer coupled to a detector inlet;

FIG. 4 shows a schematic illustration of detector including an analytical apparatus including two spectrometers coupled to a detector inlet; and

FIG. 5 illustrates a method of operating a detector for detecting a substance of interest.

In the drawings like reference numerals are used to indicate like elements.

### DETAILED DESCRIPTION

Embodiments of the disclosure relate to detector inlets for providing samples to an analytical apparatus for detecting a substance of interest. Detectors such as mass spectrometers and ion mobility spectrometers may be configured to ionise a vapour, and then to analyse the ions generated from that vapour to detect substances of interest. Such detectors may be configured to inhale a flow of gaseous fluid from an environment to be tested, and then to take samples from this flow. The samples can then be tested to detect the presence of substances of interest. The gaseous fluid may include gas, such as air, vapour and aerosols, for example solid or liquid particles suspended in the gaseous fluid.

An analytical apparatus configured to analyse vapour samples can analyse vapours present in the environment being sampled from directly. However, aerosols in the environment may need to be vaporised by heating an aerosol-containing flow of air to facilitate satisfactory analysis of the vaporised aerosol. A heater can be placed in the path of a sample drawn into an inlet of the detector to heat the sample to vaporise aerosols. However, when the heater is not operated, for example to sample vapours where powering the heater is not required, substances may deposit on the heater and cause contamination, requiring thorough flushing of the apparatus whilst heating to desorb contaminants. Conversely, when such a heater is operated during sampling of vapours in the environment, power is unnecessarily expended. Sensitivity of the detector for detecting vapours may also be degraded when the vapour sample is heated in the inlet of the detector.

Embodiments of the disclosure relate to the provision of samples to an analytical apparatus via multiple sampling pathways that can be opened and closed to select the pathways through which samples are provided to the analytical apparatus. In particular, embodiments of the disclosure relate to detector inlets including separate sampling pathways for sampling vapours and for sampling and vaporising aerosols. Separate pathways for sampling vapour and aerosols for providing to an analytical apparatus can permit reduction in weight and size of a detector, for example a portable detector, and can reduce power requirements by allowing heating of inhaled samples to be limited.

Particular embodiments of the disclosure relate to a detector inlet including a first sampling pathway configured to receive a first flow of air including a vapour for sampling by the analytical apparatus, and a second sampling pathway configured to receive a second flow of air, the second sampling pathway including a heater configured to heat an aerosol, present in the second flow of air, to vaporise the aerosol for sampling by the analytical apparatus. The detector inlet is operable to open and close each of the first and second sampling pathways to enable at least one of the first flow of air and the second flow of air. Thus, when a sampling pathway is open, the detector inlet enables a flow of air to enter the sampling pathway for sampling by the analytical apparatus. The detector inlet can therefore be controlled to provide a sample to the analytical apparatus based on a particular substance of interest to be detected, for example different sampling pathways can be selected depending on whether one or more substances of interest are known or likely to be present in the form of an aerosol or a vapour.

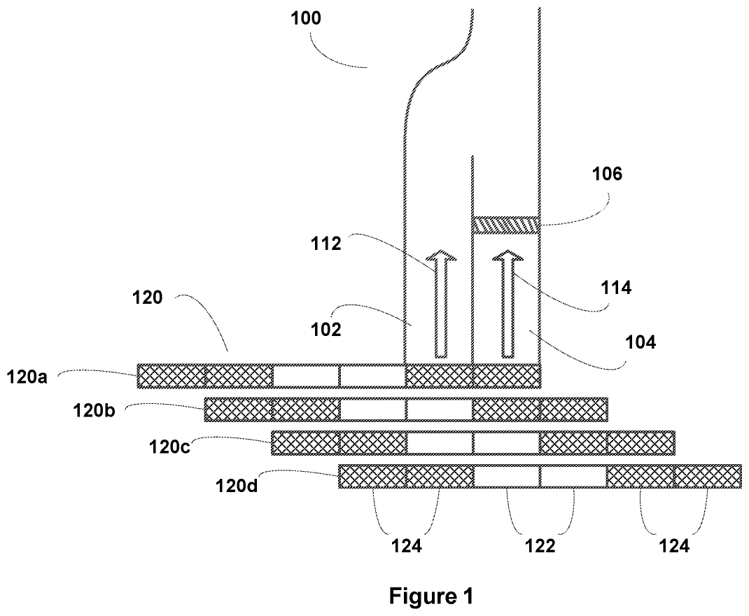

FIG. 1 shows a detector inlet 100 including a first sampling pathway 102 and a second sampling pathway 104, separate from the first sampling pathway 102. The first sampling pathway 102 is configured to receive a first flow of air 112 for analysis by an analytical apparatus 302 (not shown in FIG. 1). The second sampling pathway 104 is configured to receive a second flow of air 114 and includes a heater 106 configured to heat the second flow of air 114 to vaporise aerosols present in the second flow of air 114. In the embodiment shown in FIG. 1, the first sampling pathway is configured for receiving vapours present in an external ambient environment for sampling by an analytical apparatus and the first sampling pathway does not include a heater.

The detector inlet 100 is operable to open and close each of the first and second sampling pathways 102/104, to select at least one of the first and second sampling pathways. For example, as shown schematically in FIG. 1, the detector inlet may include a selector 120 for opening and closing the first and second sampling pathways 102/104. The selector 120 may include one or more open portions 122 and one or more closed portions 124 that can be aligned with the first and second sampling pathways 102/104 to selectively allow air from an environment to be sampled to enter each sampling pathway. When a sampling pathway is aligned with an open portion, air can be drawn from an environment to be sampled into the sampling pathway, for example from an ambient environment in which the detector is situated, and when a sampling pathway is aligned with a closed portion, air is not permitted to be drawn into the sampling pathway from the environment.

The detector inlet 100 may be operable to open and close each of the first and second sampling pathways 102/104 to select any one of the first sampling pathway 102 only, the second sampling pathway 104 only, both the first sampling pathway 102 and the second sampling pathway 104, or to close both of the first and second sampling pathways 102/104.

As illustrated in FIG. 1, the selector 120 may be operable to occupy a plurality of positions 120a, 120b, 120c and 120d to vary the alignment of open portions 122 and closed portions 124 with the first and second sampling pathways 102/104. In position 120a, both the first sampling pathway 102 and the second sampling pathway 104 are aligned with closed portions 124, which can correspond to when the detector inlet is not being used, for example in order to prevent contamination of the detector. In position 120b, only the first sampling pathway 102 is aligned with an open portion 122, while the second sampling pathway 104 is aligned with a closed portion 124. Where only the first sampling pathway 102 is open, the detector can conserve power by not requiring the heater 106 to be operated, which may be important in a battery powered or portable detector, whilst also avoiding deposition of contaminants on the heater. In position 120c, both the first sampling pathway 102 and the second sampling pathway 104 are aligned with open portions 122, enabling sampling through both the first and second sampling pathways 102/104 at the same time. Thus, vapours in the first flow of air 112 can be sampled and analysed without being subject to direct heating, while aerosols in the second flow of air 114 can simultaneously be vaporised for analysis. Finally, in position 120d, only the second sampling pathway 102 is aligned with an open portion 122, while the first sampling pathway 104 is aligned with a closed portion 124.

While FIG. 1 depicts selector 120 schematically as being operable to cycle through open and closed arrangements of the first and second sampling pathways 102/104 by aligning open and closed portions 122/124, the first and second sampling pathways 102/104 may be opened and closed by any suitable method. For example, sampling pathways 102/104, or any additional sampling pathways, may include separately actuatable closing elements for opening and closing each sampling pathway.

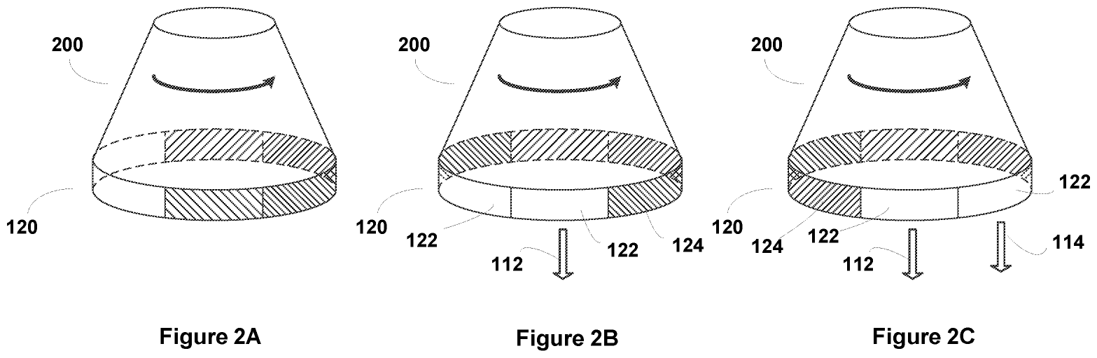

In embodiments, such as are illustrated in FIGS. 2A to 2C, the detector inlet 100 may include a cap 200 configured to cover respective entrances to the first and second sampling pathways 102/104. The cap 200 may include a protective rain cap for covering and preventing contaminants entering or damage to the detector inlet, for example when a portable or handheld detector is being carried. As shown in FIG. 2, the cap 200 may in some embodiments include a generally conical structure and have the form of a frustum, but the shape of the cap is not limited and a cap may have any suitable shape and cross-section.

With reference to FIGS. 2A to 2C, the cap 200 can include the selector 120 and can be actuatable by a user to control opening of the first and second sampling pathways 102/104. For example, the cap 200 may be actuatable to open and close the first and second sampling pathways 102/104 depending on its orientation and in some embodiments may be user-actuatable by rotation of the cap to open and close the first and second sampling pathways 102/104. The cap 200 as shown in FIGS. 2A to 2C includes a selector 120 including a plurality of open portions 122 and closed portions 124 and is positioned over an entrance to the first sampling pathway 102 for receiving a first flow of air 112 and an entrance to the second sampling pathway 104 for receiving a second flow of air 114. In FIG. 2A, the entrances to the first and second sampling pathways are aligned with closed portions 124 of the selector 200 and air flow into the first and second sampling pathways 102/104 is blocked. In FIG. 2B, the cap 200 is rotated by 60° and the entrance 202 to the first sampling pathway 102 is aligned with an open portion 122 of the cap, enabling the first flow of air 112 into the first sampling pathway 102. In FIG. 2C, the cap 200 is rotated by a further 60° and, in addition to the entrance 202, the entrance 204 to the second sampling pathway 104 is aligned with an open portion 122 of the cap, enabling the first flow of air 112 and the second flow of air 114 into the first and second sampling pathways 102/104, respectively. While in FIG. 2, 4 closed portions 124 and 2 open portions 122 are shown, it will be appreciated that in some embodiments, corresponding portions may be continuous and not defined by multiple discrete portions. For example, in the embodiment shown in FIG. 2, the closed portions 124 may include a continuous closed portion extending around the cap 200 bounded by the two open portions 122, which may in some embodiments include a single continuous open portion.

While FIG. 2 illustrates rotation of a cap 200 to open and close the first and second sampling pathways 102/104, actuation to control opening of the sampling pathways may not be rotational. For example, the actuation may include a linear movement of a cap or other user manipulable selector to open and close the sampling pathways, which may function by alignment of open and closed portions of a selector 120 as shown in FIG. 1, or in some embodiments may include actuation of individual closing elements or caps on each sampling pathway. In some embodiments, a selector may be separate from the cap, for example the detector inlet may include a cap covering entrances to sampling pathways, and a separate selector operable, for example user-actuatable, to control opening and closing of the sampling pathways.

In embodiments, the operation of the detector is controlled based on the arrangement of the detector inlet 100, such as the open or closed status of the sampling inlets. For example, the detector inlet 100 may be configured to provide a signal for activating the analytical apparatus when the first or second sampling pathway 102/104, or an additional sampling pathway, is open. Similarly, the detector inlet 100 may be configured to provide a signal for deactivating the analytical apparatus when all sampling pathways are closed, for example when the first and second sampling pathways, 102/104 are closed. Thus, in embodiments, the cap 200 described previously may be user actuatable to simultaneously select and open one or more sampling pathways and to provide a signal for activating the analytical apparatus and/or for providing power to other parts of the detector such as a user interface or control electronics. In embodiments, the detector inlet 100 may be configured to provide a signal, for example to a controller of the detector, indicating which sampling pathways are open.

As discussed, the second sampling pathway 114 includes a heater 106. For example, the heater 106 may be arranged within the second sampling pathway 114 or at least partially within it, for example at an entrance to the second sampling pathway or at an exit from the first conduit to a sampling volume. In some such examples one or more internal walls of the second sampling pathway 104 may include the heater. The heater may include a conductor, such as a wire which may be arranged to be heated by resistive heating. The wire may include metal. The heater 106 may be arranged as a grid or mesh to provide an obstacle in the inlet so that the second flow of air 114 through the second sampling pathway 104 flows through or around the heater 106, for example wire arranged in the path of the second flow of air 114 so that the second flow of air 114 must pass the wire to reach the analytical apparatus. In one example the heater 106 includes a knitted structure, such as a wad or tangle of wire. One example of such a structure includes a knitted mesh of wire such as Knitmesh®.

The grid or mesh structure may be arranged so that the wire occupies less than 80% of its volume, in some examples less than 60%, in some examples less than 40%, in some examples less than 20% of the volume is occupied by wire, and the remaining volume may be occupied by air spaces through which air to be heated can flow. In an embodiment the structure is at least 60% air by volume, and in some embodiments the structure is approximately 70% air by volume. The use of lower densities may improve the efficiency of the apparatus, and the sensitivity achieved by heating the airflow. Where a knitted or tangled wire structure, such as Knitmesh®, is used, the heater 106 may be wrapped around the outside of the structure. In some embodiments the knitted or tangled wire structure may be heated by passing a current through the structure. The heater 106 may provide a constriction in the second sampling pathway 104, or it may be arranged around a constriction in the path of the second flow of air 114. In some examples the heater 106 may include an infra-red source, such as an infra-red lamp or LED, or an infra-red laser. In some examples the heater 106 may include a jet, or a plurality of jets, of hot air injected into the second flow of air 114 in the second sampling pathway 104 before the flow of air is provided to the analytical apparatus for sampling.

Although the first and second sampling pathways 102/104 are illustrated schematically in FIG. 1 as being parallel adjacent passages separated by common internal wall, the first and second sampling pathways 102/104, and/or any additional sampling pathways, may be provided in other arrangements. For example, different sampling pathways may be aligned in different directions, for example to provide flow to the analytical apparatus from different directions, such as when different sampling pathways draw air from entrances that are separated on the surface of the detector.

In embodiments, the second sampling pathway 104 can include a trap for collecting aerosols when the heater 106 is off. The trap may include an obstruction arranged to capture aerosols in the second flow of air 114, where the trap can subsequently be heated with the heater 106 to vaporise aerosols that are collected on the trap. For example, the trap may include the heater 106. The trap may therefore include a wire structure as described previously (e.g. a grid, mesh or a knitted or tangled wire structure, such as Knitmesh®), where the wire structure is arranged to collect aerosols on the wire structure when the heater 106 is off.

As discussed, the detector inlet 100 can receive air to be sampled from an ambient environment in which the detector is situated. In some instances, samples for analysis can also be collected on a sample swab by swabbing a surface and subsequently provided to a detector for analysis. Thus, in some embodiments the detector inlet 100 may be configured to receive a sample swab to provide a sample desorbed from the sample swab to the analytical apparatus. For example, the detector inlet 100 may be configured to receive a sample swab and to provide a sample desorbed from a sample swab to the first or the second sampling pathway 102/104. In particular, a vapour sample desorbed from a sample swab may be provided to the first sampling pathway 102, for example the detector inlet 100 may be configured to receive a sample swab so that the first flow of air 112 into the first sampling pathway 102 must pass the sample swab in order to pass through the first sampling pathway 102, for example where a sample swab can be positioned at an entrance to the first sampling pathway 102.

The detector inlet 100 may include a swab heater configured to heat a sample swab to desorb a sample present on the sample swab. For example, a swab heater may be arranged upstream of an entrance to the first sampling inlet 102. Alternatively or additionally, the detector inlet 100 may be configured to receive a probe such as a sample collection wand, including a swab heater and the sample swab. In some embodiments, the detector inlet may be configured to provide power to a swab heater on a probe, for example where the detector inlet includes a coupling to provide electrical power to a swab heater on a probe, or an inductive coupler to inductively heat a swab or a swab heater on a probe.

While FIGS. 1 and 2 show only first and second sampling pathways 102/104, in embodiments the detector inlet 100 may include one or more additional sampling pathways for receiving a respective additional flow of air for sampling by the analytical apparatus. The detector inlet may also be operable to open and close the one or more additional sampling pathways as described in relation to the first and second sampling pathways 102/104. The one or more additional sampling pathways may be adapted to receive different samples to the first and/or second sampling pathways, and/or may be adapted to process samples differently within an additional pathway.

In embodiments, the one or more additional sampling pathways can include a third sampling pathway for receiving a sample swab, where the detector inlet 100 is operable to open and close the third sampling pathway to enable a third flow of air into the third sampling pathway. The detector inlet 100 may be configured for receiving a sample swab as describe previously but instead of providing a desorbed sample from a sample swab to the first or the second sampling pathway, a third sampling pathway may be provided for receiving a sample desorbed from a sample swab and providing a sample desorbed from the sample swab to the analytical apparatus. In embodiments, the third sampling pathway may include a swab heater configured to heat a sample swab to desorb a sample for sampling by the analytical apparatus. The swab heater may be disposed so that a third flow of air into the third sampling pathway must pass a sample swab heated by the swab heater in order to pass through the third sampling pathway. For example, the swab heater may be fully or at least partially within the third sampling pathway and the detector inlet configured to permit a sample swab or probe including the sample swab to be at least partially inserted into the third sampling pathway, and the third flow of air drawn past the sample swab to provide desorbed sample to the analytical apparatus. The detector inlet 100 may be operable to open and close the third sampling pathway to enable insertion of a sample swab as well as to enable the third flow of air. In embodiments, the detector inlet may not include a swab heater but be configured to receive a probe including a sample swab, where the probe may include a swab heater. The detector inlet may provide power to a swab heater on a probe to desorb a sample from a swab for sampling by the analytical apparatus via the third sampling pathway.

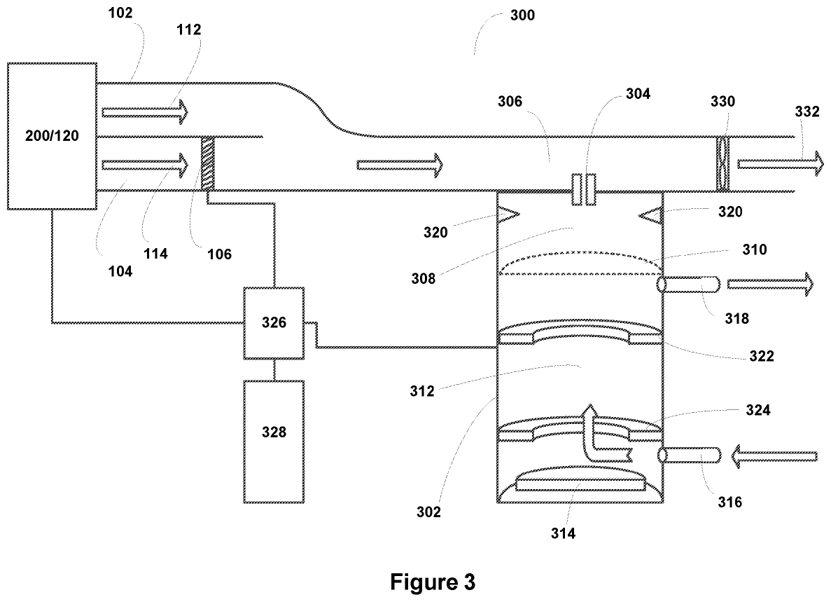

FIG. 3 shows a detector 300 including detector inlet 100 and an analytical apparatus including a spectrometer 302 having a sampling port 304 for obtaining samples for analysis from a sampling volume 306 into the spectrometer 302. The detector may be portable, for example a handheld detector, and may include a portable power source 328 that can be carried by the detector. A portable power source may include a battery, a fuel cell, a capacitor, or any other portable source of electrical power suitable for providing electrical power to the detector.

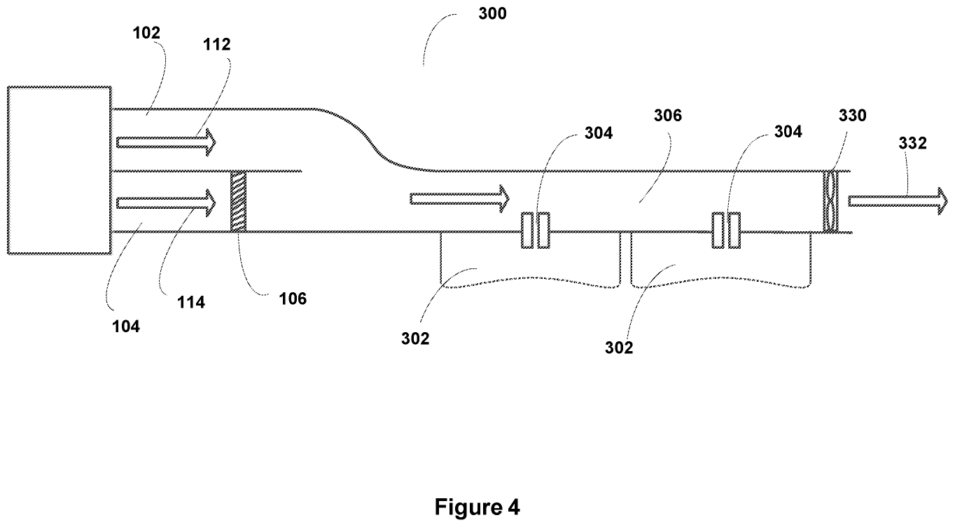

As depicted in FIGS. 3 and 4, first and second sampling pathways 102/104 of the detector inlet 100 are configured to provide vapour or vaporised aerosols to a common sampling volume 306 from which the analytical apparatus obtains samples for analysis through one or more sampling ports 304. The one or more sampling ports 304 may include a sampling inlet such as a pinhole, capillary or membrane inlet. In embodiments, the one or more sampling ports 304 include one or more pinhole inlets.

In FIG. 3, the spectrometer 302 includes an ion mobility spectrometer which is coupled to the sampling volume 306 by a sampling port 304 and includes a reaction region 308 in which a sample can be ionised. The sampling port 304 can be operated to obtain a sample from the sampling volume 306 into the spectrometer 302. A gate electrode 310 may separate the reaction region 308 from a drift chamber 312. The drift chamber 312 includes a collector 314 toward the opposite end of the drift chamber 312 from the gate electrode 310. In other embodiments, an ion mobility spectrometer may be operated with an ion trap holding and releasing sample ions in place of the gate electrode 310. The drift chamber 312 also includes a drift gas inlet 316, and a drift gas outlet 318 arranged to provide a flow of drift gas along the drift chamber 312 against the direction of movement of sample ions towards the collector 314, for example a drift gas flow is provided from the collector 314 towards the gate 310. The sampling port 304 can be operated to sample air from the sampling volume 306 into the reaction region 308 of the spectrometer 302. The reaction region 308 includes an ioniser 320 for ionising a sample. In the example shown in FIG. 3 the ioniser 320 includes a corona discharge ioniser including electrodes. The drift chamber 312 also includes drift electrodes 322, 324, for applying an electric field along the drift chamber 312 to accelerate ions towards the collector 314 against the flow of the drift gas. The detector may include a sampler (not shown) configured to draw a selected volume of fluid, smaller than the sampling volume 306, through the sampling port 304 to provide a sample to the analytical apparatus. The sampler may include an electromechanical actuator, for example a solenoid driven actuator, and/or a mechanical pump arranged to transfer vapour from the sampling volume 304 through the sampling port 304 and into the analytical apparatus/spectrometer 302.

The detector 300 may include a flow provider for drawing air through sampling pathways and past one or more sampling ports of the analytical apparatus. As shown in FIG. 3, detector 300 includes a flow provider 330 configured to draw air through the first and second sampling pathways 102/104 to a sampling volume 306 and past the sampling port 304. The flow provider 330 can be configured to provide an exhaust flow 332 downstream of the sampling volume 306 and sampling ports 304. The flow provider may for example be provided by a pump, or a fan or any device suitable for drawing a flow of air through the sampling pathways to a sampling volume 306 and sampling port 304, such as bellows. Where such a flow provider is used, it may in some instances not be part of the detector and may be provided separately.

The detector 300, as shown in FIG. 3, can include a controller 326 configured to control operation of the detector. For example, the controller may be coupled to, for example to control or to electronically communicate with, the heater 106, the analytical apparatus such as spectrometer 302, the flow provider 330 and the selector 120/cap 200. The controller 326 may include a processor and a memory storing instructions for operation of the detector 300.

In operation of the detector 300, for example in response to an activation signal and a sampling pathway being open, the controller 326 operates the flow provider 330 so that one or more respective flows of air are drawn through open sampling pathways and into the sampling volume 306. The controller then operates the detector to draw a sample in the sampling volume 306 through one or more sampling ports 304 into the analytical apparatus/spectrometer 302 for analysis.

The controller 326 may be configured to turn on the detector in response to receiving a signal that one or more sampling pathways are open, for example to activate the analytical apparatus and/or to provide power to other components of the detector such as a user interface. In some embodiments, the controller 326 may be powered in response to a signal that a sampling pathway is opened.

In embodiments, the controller 326 is configured to control operation of the detector 300 based on the selected sampling pathways. For example, the controller 326 may be configured to control operation of the detector 300 according to one or more detection protocols that are selected based on the open sampling pathways. A sampling pathway may be selected as a result of the controller receiving a signal that the sampling pathway is open. For example, the controller 326 may be configured to receive a signal from the selector 120/cap 200 indicating which sampling pathways are open, for example based on the orientation of the selector 120/cap 200. Although selector 120/cap 200 is shown in FIG. 3 as being linked to the controller 326, the detector inlet 100 may include means, such as one or more sensors, separate from the selector 120/cap 200 for providing a signal to the controller 326 indicating which sampling pathways are open. Alternatively or additionally, sampling pathways may be selected based on an indication from a user of which sampling pathways are required. In embodiments, the controller 326 may control opening and closing of the sampling pathways to only open selected sampling pathways, for example the controller may be configured to control the selector 120.

In embodiments, the controller is configured to receive an indication of which of the first and second sampling pathways 102/104 are open (or are selected to be opened), and to control operation of the heater based on whether the second sampling pathway is open. The controller 326 can be configured to provide power to the heater 106 for heating an aerosol in the second sampling pathway 104 only in the event that the second sampling pathway 104 is open. For example, power may be provided to the heater 106 in response to the second sampling pathway 104 being opened or in response to a signal to operate the detector to perform analysis when the second sampling pathway 104 is open. When the second sampling pathway 104 is closed, the detector can conserve power by avoiding the need to provide power to the heater 106, for example when only vapour detection through the first sampling pathway 102 and/or sampling through an additional sampling pathway is required.

The controller 326 may be configured to control the heat output of the heater 106 to vary the temperature and/or timing of the heating. In embodiments the controller 326 is configured to control the heater 106 and flow provider 330 to desorb residues which may have accumulated in the second sampling pathway 104 or on the heater 106. For example, the controller 326 is configured to activate the heater 106 for a first time period whilst drawing air through the second sampling pathway 104 to enable substances desorbed from the second sampling pathway 104 to leave the detector inlet 100 and sampling volume 306. After the first time period has elapsed, whilst the flow provider continues to draw air though the second sampling pathway 104 past the heater 106, the second flow of air 114 drawn past the heater 106 is heated to vaporise aerosols in the second flow of air 114 for sampling by the analytical apparatus/spectrometer 302. To desorb residues, the heater 106 may be heated to a temperature of at least 150° C. The flow of air through the second sampling pathway 104 then flushes desorbed substances out of the detector in preparation for testing a sample of air. The heat output of the heater 106 during sampling of the second flow of air to vaporise aerosols may be less than the heat output during the first time period to desorb residues. For example, the heater 106 may be controlled to reduce power provided to the heater 106, for example by switching it off, after the first time period and the second flow of air 114 heated at a lower power or while the heater is cooling. Where the second sampling pathway 104 is open at the same time as another sampling pathway, for example the first sampling pathway 102, the controller may be configured to delay operation of the analytical apparatus to analyse samples from the first sampling pathway 102 until after the first time period in which residues are desorbed from the second sampling pathway 104 and the heater 106. In some embodiments, desorption of residues from the second sampling pathway 104 may be performed when only the second sampling pathway 104 is open, prior to opening any other sampling pathways.

In some embodiments, the controller is configured to control the heater 106 to provide a heat output after a sample including aerosols is accumulated in the second sampling pathway 104. For example, the second sampling pathway may include a trap for collecting aerosols when the heater 106 is not heating, and the heater 106 can then be operated to desorb the accumulated aerosols for sampling by the analytical apparatus. The controller 326 may for example, in response to receiving an indication that second sampling pathway 104 is open and an indication that aerosol accumulation is required, activate the flow provider 330 to draw a flow of air into the second sampling pathway 104 past the trap (for example through the trap) for an accumulation time period without heating the trap to desorb aerosols, and then after the accumulation time period has elapsed to control the heater 106 to heat the trap to desorb aerosols from the trap for analysis. The trap may include any suitable device for accumulating aerosols from a flow of air such that the trap can be heated by the heater 106 to desorb the accumulated aerosols. For example, the trap may include the heater 106 such that trapping the aerosols includes accumulating aerosols on the heater 106, for example on a heater including a wire mesh or grid as described previously, through which a flow of air may pass to deposit aerosols on the trap.

The detector may be operable by a user to select whether accumulation of aerosols is required, and, in the event that no indication that accumulation of aerosols is required when the second sampling pathway 104 is open, the controller 326 can control the heater 106 to vaporise aerosols in the second flow of air 114 without an accumulation step. In some embodiments, a trap and a heater for heating the trap (where the trap may include the heater) can be disposed in an additional sampling pathway instead of in the second sampling pathway 104, such that the controller 326 only controls the trap heater and the flow provider to accumulate aerosols when that additional sampling pathway is open.

Where the detector inlet 100 includes a third sampling pathway for receiving a sample swab as discussed previously, the controller 326 can provide power to a swab heater of the detector inlet 100, or provide power to a swab heater on a probe, in response to the third sampling pathway being opened, or in response to receiving a signal that a swab or probe is positioned at the detector inlet 100 for providing a sample to the third sampling pathway. For example, the controller may be configured to provide power to a swab heater in response to insertion of a probe into the detector inlet 100. Where heating of a sample swab is performed by an externally controlled heater, for example on a heated probe or sampling wand, the controller 326 may be configured to operate the flow provider 330 in response to receiving a signal that a swab is positioned for providing a sample to the third sampling pathway, for example in response to insertion of a probe.

In some embodiments, the trap for accumulating aerosols described previously may be separate from the detector and may be an add-on component that can be positioned at the detector inlet and heated to desorb accumulated aerosols as described in relation to the sample swab. For example, the controller 326 may, in response to a signal to accumulate aerosols on an external trap, draw a flow of air into a sampling pathway past the trap to accumulate aerosols on the trap, and then provide power to heat the trap to desorb accumulated aerosols whilst drawing air (for example continuing to draw air) into the sampling pathway of the detector inlet 100 past the trap.

In embodiments, the controller 326 is configured to control the flow provider 330 to inhale air into at least one sampling pathway and through the sampling volume 306 past sampling port 304, through which samples are drawn by an analytical apparatus. When a sampling pathway is open, operation of the flow provider 330 draws air, for example from an external ambient environment, into that sampling pathway and then to sampling volume 306. The flow provider 330 then directs an exhaust flow 332 from the sampling volume 306, and the detector can be configured to expel the exhaust flow 332 from the detector.

The controller may be configured to control operation of the flow provider 330 based on the open sampling pathways. For example, in the event that multiple sampling pathways are open, the flow provider 330 may be controlled to increase the flow rate based on the number of open sampling pathways to maintain flow through each individual sampling pathway above a threshold. Where fewer sampling pathways are selected, the power to the flow provider 330 may be reduced to conserve power. In some embodiments, the flow provider 330 is configured to provide a single flow rate regardless of which sampling pathways are open. For example, the flow provider 330 may be configured to provide a single flow rate that is sufficient to draw air for sampling through all of the sampling pathways that can be opened simultaneously.

The sampling volume 306 is disposed between the sampling pathways (for example the first and second sampling pathways 102/104) and an outlet from which the exhaust flow 332 is extracted. For example, as shown in FIGS. 3 and 4 the sampling volume 306 may include a flow passage arranged to receive a flow of air including samples from at least the first and second sampling pathways 102/104 (and in some embodiments any additional flow of air from additional sampling pathways, for example a third sampling pathway as described previously) and carry the flow of air including samples past the sampling ports 304 to an exhaust 332.

The sampling pathways or flow passages described herein are illustrated as being arrangements of conduits, such as hoses or pipes. However, they may also be provided by channels, and plenums, which are cut into a block of material, and then enclosed. In the examples illustrated in FIGS. 1, 3 and 4, the sampling pathways and/or the flow passage including the sampling volume may be less than 20 mm wide. For example, less than 10 mm wide, for example less than 5 mm, for example less than 2 mm, for example less than 1.5 mm, for example less than 1 mm, for example less than 0.75 mm, for example less than 0.5 mm, for example less than 0.4 mm, for example less than 0.3 mm, for example less than 0.2 mm, for example less than 0.1 mm. In the Examples illustrated in FIGS. 1, 3 and 4, the sampling pathways and/or the flow passage including the sampling volume may be at least 10 microns wide, for example at least 0.1 mm wide. For example, at least 0.2 mm, for example at least 0.3 mm, for example at least 0.4 mm, for example at least 0.5 mm, for example at least 0.75 mm, for example at least 1 mm, for example at least 1.5 mm, for example at least 2 mm, for example at least 5 mm wide.

In some instances, the detector 300 may be used in the presence of dust and grit and other particulate matter. Such particulates may obstruct or otherwise damage or contaminate the detector. In embodiments, the detector 300 is configured so that the flow provider 330 draws a flow of air to be sampled past one or more sampling ports 304 of the analytical apparatus to permit sampling of vapour in the flow whilst drawing particulates present in the flow past the one or more sampling ports 304 without entering the one or more sampling ports 304. Whilst the analytical apparatus is configured to sample vapours, some particulates or aerosols may nonetheless enter the sampling ports 304, however the sampling ports 304 may be arranged to reduce the proportion of particulates or aerosols drawn through the sampling ports 304 when a vapour is sampled. As shown schematically in FIGS. 3 and 4, sampling ports 304 may be configured to draw samples into the analytical apparatus in an orthogonal direction to the direction of bulk flow through the sampling volume 306 to the exhaust 332 to reduce particulates entering or blocking the sampling ports 304. In embodiments, the detector may include one or more flow directors configured to alter the distribution of particulates within the sampling volume to increase the proportion of particulates that pass the sampling inlet without being drawn into the sampling inlet. For example, a flow director may include a change in cross-section of the flow passage including the sampling volume or a change of direction of flow within the flow passage to provide a volume adjacent the sampling port 304 having a reduced proportion of particulates present. For example, a flow director may protrude from a wall of the flow passage, where a sampling port 304 is arranged on a wall of the flow passage downstream of the flow director. Alternatively, the sampling port 304 may be arranged on the inside of a bend in the flow passage, or at the centre of a circulatory flow within the flow passage such that centrifugal effects reduce the proportion of particulates in a region adjacent the sampling port 304.

While FIG. 3 depicts an ion mobility spectrometer, the analytical apparatus may include at least one of an ion mobility spectrometer (IMS), a differential mobility spectrometer (DMS), a mass spectrometer (MS), a chromatography apparatus (for example a gas chromatography system) and an optical spectrometer (for example an infrared spectrometer or a Raman spectrometer). In embodiments, the analytical apparatus may include an ion mobility spectrometer, a mass spectrometer, or a combined IMS-MS. An IMS may include a positive IMS and/or a negative mode IMS. In embodiments the analytical apparatus includes both a positive mode IMS and a negative mode IMS configured to analyse samples from a single sampling volume. In some embodiments a single IMS may be switchable between positive and negative modes and may be configured to rapidly switch between positive and negative modes in order to analyse a single sample in both the positive and negative modes.

The controller 326 may be configured to receive an indication from the analytical apparatus that a substance of interest is detected, or is not detected, and to provide an indication to a user, such as to provide an alert to a user that a substance of interest is detected.

In some embodiments, operating parameters of the analytical apparatus, and/or parameters for data analysis, may be selected based on the open sampling pathways. For example, where different sampling pathways are intended to detect different substances of interest, operating parameters of an analytical apparatus such as a spectrometer may be controlled to enable or improve detection of a targeted substance. For example, where a sampling pathway is intended to detect substances of interest that result in one or more specific peaks in a spectrum, operating parameters of a spectrometer or analysis of resulting data may be controlled to focus on the relevant peaks, and/or to exclude areas of a spectrum that are not relevant to expected substances of interest.

FIG. 4 shows a detector 300 as shown in FIG. 3, where the analytical apparatus includes two spectrometers 302 having two respective pinhole sampling ports 304. The two spectrometers 302 may, for example, include a positive mode IMS and a negative mode IMS. While the two sampling ports 304 are illustrated in FIG. 4 as being separated along the bulk flow direction from the sampling pathways 102/104 to the exhaust 332, any suitable arrangement may be used depending on the requirements and internal structure of the detector 300. For example, the two sampling ports 304 (and in embodiments respective spectrometers 302) may be separated around the periphery or circumference of a flow passage including the sampling volume 306, for example the sampling ports 304 may each be substantially the same distance from the sampling pathways 102/104 such as disposed at opposing sides the flow passage or disposed adjacent to each other on a wall of the flow passage and separated in a direction perpendicular to the bulk flow direction. While not shown in FIG. 4 for clarity, it will be appreciated that the controller 326 and portable power source 328 may be present as shown in FIG. 3, and the controller 326 may be coupled to and control operation of both spectrometers 302 in FIG. 4.

Whilst the apparatuses shown in FIGS. 1 to 4 provide embodiments of the present disclosure, other embodiments are contemplated.

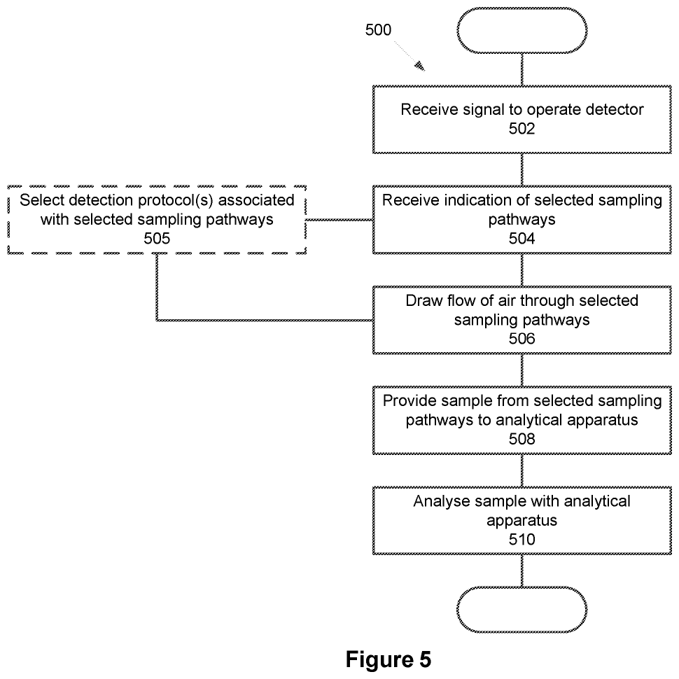

FIG. 5 illustrates a method 500 of operating a detector for detecting a substance of interest in a sample, where the detector includes a plurality of sampling pathways for providing the sample to an analytical apparatus for analysis. As illustrated in FIG. 5, the method includes 502 receiving a signal to operate the detector and 504 receiving an indication of which of the plurality of sampling pathways are selected. As described herein, an indication that a respective sampling pathway is selected may be provided in the event that the respective sampling pathway is opened. Alternatively, the indication may be provided by other means, such as user input, and in such cases the method may include operating the detector to open selected sampling pathways and to close non-selected sampling pathways.

In embodiments, the method may include 505 selecting one or more detection protocols associated with the selected sampling pathways. The detection protocols may include instructions for controlling operation of the detector, wherein each sampling pathway is associated with one or more detection protocols for controlling operation of the detector. In embodiments, a detection protocol may be selected based on a particular combination of different sampling pathways being selected together.

The method includes 506 drawing one or more respective flows of air through only the selected sampling pathways to provide a sample in the one or more respective flows of air for sampling by the analytical apparatus. At step 510, the sample is analysed with the analytical apparatus to detect a substance of interest. The method may include providing an indication, such as an alert, to a user that a substance of interest has, or has not, been detected.

In embodiments, the plurality of sampling pathways includes a first sampling pathway 102 configured to receive a first flow of air 112 including a vapour for sampling by the analytical apparatus, and a second sampling pathway 104 configured to receive a second flow of air 114, the second sampling pathway 104 including a heater 106 configured to heat an aerosol, present in the second flow of air 114, to vaporise the aerosol for sampling by the analytical apparatus, wherein the method includes heating the second sampling pathway 104, for example providing power to the heater 106, only in the event that the second sampling pathway 104 is selected. For example, the method may include receiving an indication that the second sampling pathway 104 is open, then selecting an aerosol detection protocol associated with the second sampling pathway and operating the detector according to the protocol to heat a flow of air 114 in the second sampling pathway to vaporise aerosols. In embodiments, an aerosol detection protocol may include the step of heating the heater 106 whilst drawing air through the second sampling pathway 104 to desorb residues in the second sampling pathway 104 as described previously herein.

Where the detector includes a sampling pathway including a trap for accumulating aerosols and a heater for heating the trap to desorb accumulated aerosols, the method may include, in the event that the sampling pathway including the trap is open, collecting aerosols on the trap when the heater is off, and then heating the trap to vaporise aerosols collected on the trap and to provide the vaporised aerosols to the analytical apparatus.

The sampling pathway including the trap may be the second sampling pathway 104 including the heater 106, for example wherein the heater 106 includes the trap. When the second sampling pathway 104 is selected, the method may include receiving an indication of whether accumulation of aerosols prior to heating is required (for example based on user input) and, in response to the indication, controlling the detector 300 to vaporise or accumulate aerosols as described previously. In some embodiments, the method may include separately (i) accumulating and vaporising aerosols from a trap, and (ii) heating aerosols in a flow of air as they pass through the second sampling pathway 104, with two separate corresponding sampling and analysis steps being performed by the analytical apparatus.

In embodiments, the method may include receiving an indication that a sample swab is positioned at the detector inlet 100 and drawing air into a sampling pathway of the detector inlet past the sample swab whilst it is heated to desorb a sample for analysis. The method may include, in response to an indication that a sample swab or probe including a sample swab is positioned at the detector inlet 100, heating the sample swab to desorb vapour, for example by operating a swab heater at the detector inlet or providing power to a heater on the swab or swab probe.

It will be appreciated that the detector referred to in relation to the methods may include a detector 300, for example as shown in FIGS. 1 to 4, and the method may include controlling the detector 300 as described previously herein based on the one or more selected sampling pathways. For example, the method may include operation of a detector 300 with a controller 326 as described herein. For example, the methods may be implemented by the controller 326 according to instructions stored in a memory of the controller 326.

The controller 326 described herein may be provided by any appropriate control logic, such as analogue control circuitry and/or digital processors, examples include field programmable gate arrays, FPGA, application specific integrated circuits, ASIC, a digital signal processor, DSP, or by software loaded into a programmable processor. Aspects of the disclosure include computer program products, and may be recorded on non-transitory computer readable media, and these may be operable to program a processor to perform any one or more of the methods described herein.

Although embodiments of the disclosure have been described as having particular application in ion mobility spectrometers, the apparatus and methods described may be applied in other analysis systems where there is a need to test for vapours such as vapours associated with aerosols having a low vapour pressure.

As will be appreciated a vapour may include a substance in its gaseous phase at a temperature lower than its critical point. By contrast with a vapour or gas, an aerosol includes fine particles of solid or liquid suspended in a gas. As used herein, the term “vaporise” is used to mean converting at least some of a substance from a solid or liquid to a vapour or a gas.

Apparatus features described herein may be provided as method features, and vice versa.

It should also be appreciated that particular combinations of the various features described and defined in any aspects of the invention can be implemented and/or supplied and/or used independently. Other examples and variations will be apparent to the skilled addressee in the context of the present disclosure.

1. A detector inlet for providing a sample to an analytical apparatus for detecting a substance of interest, the detector inlet comprising:
a first sampling pathway configured to receive a first flow of air comprising a vapour for sampling by the analytical apparatus; and
a second sampling pathway configured to receive a second flow of air, the second sampling pathway comprising a heater configured to heat an aerosol, present in the second flow of air, to vaporise the aerosol for sampling by the analytical apparatus;
wherein the detector inlet is operable to open and close each of the first and second sampling pathways to enable at least one of the first flow of air and the second flow of air.

2. A detector inlet according to claim 1, wherein the detector inlet is operable to open and close each of the first and second sampling pathways to open the first sampling pathway only, open the second sampling pathway only, open both the first sampling pathway and the second sampling pathway, and to close both of the first and second sampling pathways.

3. A detector inlet according to claim 1, wherein the detector inlet is configured to provide a signal for activating the analytical apparatus in response to the first or second sampling pathway being opened, and/or to provide a signal for deactivating the analytical apparatus in response to the first and second sampling pathways being closed.

4. A detector inlet according to claim 1, wherein the detector inlet comprises a cap configured to cover respective entrances to the first and second sampling pathways, wherein the cap is user-actuatable by rotation of the cap to control opening of the first and second sampling pathways.

5. (canceled)

6. A detector inlet according to claim 1, wherein the first and second sampling pathways are configured to provide vapour or vaporised aerosols to a common sampling volume from which the analytical apparatus draws samples for analysis through one or more sampling ports, and wherein the one or more sampling ports comprise one or more capillary inlets, membrane inlets, or pinhole inlets.

7. (canceled)

8. A detector inlet according to claim 1, wherein the detector inlet is configured to receive a sample swab to provide a sample desorbed from the sample swab to the analytical apparatus, for example wherein the detector inlet is configured to provide a sample desorbed from a sample swab to the first sampling pathway, and wherein the detector inlet comprises a swab heater configured to heat a sample swab to desorb a sample present on the swab, or wherein the detector inlet is configured to receive a probe comprising a swab heater and the sample swab.

9. (canceled)

10. A detector inlet according to claim 1, comprising one or more additional sampling pathways for receiving a respective additional flow of air for sampling by the analytical apparatus, wherein the detector inlet is operable to open and close the one or more additional sampling pathways, and wherein the one or more additional sampling pathways comprises a third sampling pathway for receiving a sample swab, for example wherein the third pathway comprises a swab heater configured to heat the sample swab to desorb a sample for analysis, or wherein the detector inlet is configured to provide power to a swab heater on a probe comprising the sample swab.

11. (canceled)

12. A detector inlet according to claim 1, wherein the heater configured to heat an aerosol comprises wire arranged in the path of the second flow of air so that the second flow of air must pass the wire to reach the analytical apparatus.

13. A detector comprising a detector inlet according to claim 1 and an analytical apparatus configured to receive a sample from the detector inlet.

14. A detector according to claim 13, comprising a controller configured to control operation of the detector based on the open sampling pathways, for example wherein the controller is configured to receive an indication of which of the first and second sampling pathways are open, and to control operation of the heater based on whether the second sampling pathway is open.

15. A detector according to claim 14, wherein the controller is configured to provide power to the heater for heating an aerosol only in the event that the second sampling pathway is opened.

16. A detector according to claim 14, wherein the controller is configured to activate the heater for a first time period whilst drawing air through the second sampling pathway to enable substances desorbed from the second sampling pathway to leave the detector inlet, and after the first time period to draw the second flow of air through the second sampling pathway past the heater to vaporise aerosols in the second flow of air for sampling by the analytical apparatus.

17. A detector according to claim 13, wherein the second sampling pathway comprises a trap for collecting aerosols when the heater is off, and wherein the detector is operable to draw air past the trap, for example through the trap, while the heater is off to collect aerosols on the trap and then to heat the trap to vaporise collected aerosols.

18. (canceled)

19. A detector according to claim 13, comprising a flow provider configured to draw air through the first and second sampling pathways and past one or more sampling ports of the analytical apparatus, for example wherein the flow provider is configured to draw a flow to be sampled past the one or more sampling ports of the analytical apparatus to permit sampling of vapour in the flow whilst drawing particulates present in the flow past the one or more sampling ports without entering the one or more sampling ports.

20. A detector according claim 13, wherein the analytical apparatus comprises at least one of an ion mobility spectrometer, a differential mobility spectrometer, a mass spectrometer, a chromatography apparatus or an optical spectrometer.

21. A method of operating a detector for detecting a substance of interest in a sample, the detector comprising a plurality of sampling pathways for providing the sample to an analytical apparatus, the method comprising:
receiving a signal to operate the detector and receiving an indication of which of the plurality of sampling pathways are selected; and
drawing one or more respective flows of air through only the selected sampling pathways to provide a sample in the one or more respective flows of air for sampling by the analytical apparatus.

22. A method according to claim 21, comprising operating the detector to open selected sampling pathways and to close non-selected sampling pathways, or wherein an indication that a respective sampling pathway is selected is provided in the event that the respective sampling pathway is opened.

23. A method according to claim 21, comprising controlling operation of the detector according to one or more detection protocols, wherein the one or more detection protocols are selected based on the selected sampling pathways.

24. A method according to claim 21, wherein the plurality of sampling pathways comprises a first sampling pathway configured to receive a first flow of air comprising a vapour for sampling by the analytical apparatus, and a second sampling pathway configured to receive a second flow of air, the second sampling pathway comprising a heater configured to heat an aerosol, present in the second flow of air, to vaporise the aerosol for sampling by the analytical apparatus, wherein the method comprises providing power to the heater only in the event that the second sampling pathway is selected.

25. A method according to claim 24, comprising collecting aerosols on a trap in the second sampling pathway when the heater is off, and then heating the trap to vaporise aerosols collected on the trap.

26. (canceled)
